(19) United States
(12) Patent Application Publication
(10) Pub. No.: US 2001/0055734 A1
(43) Pub. Date: Dec. 27, 2001

(54) Concentrate comprising a p-phenylenediamine derivative

(76) Inventors: Gustav Tappe, Leverkusen (DE); Wolfgang Korner, Leverkusen (DE); Gerhard Schmid, Oberriexingen (DE)

Correspondence Address: Ashley I. Pezzner, Esquire, CONNOLLY BOVE LODGE & HUTZ LLP, 1220 Market Street, P.O. Box 2207, Wilmington, DE, 19899, US

(21) Appl. No.: 09/854,499

(22) Filed: May 14, 2001

(30) Foreign Application Priority Data
May 17, 2000 (DE) 100 24 263.4

(51) Int. Cl. G03C 5/30

(52) U.S. Cl. 430/466; 430/490; 430/484

(57) ABSTRACT

A concentrated aqueous solution of a p-phenylenediamine derivative, which a) has a pH higher than 12.5, b) contains 0.4 to 1.1 mol p-phenylenediamine derivative/litre, c) contains 0.05 to 2 mol of an antioxidant/litre, d) contains at most 35% by weight of organic solvents with respect to the total solution, e) contains at most 50 mmol sulphate ions/litre and f) is single-phase, is suitable for the production of different colour developer formulations.

This invention relates to a concentrated solution of p-phenylenediamine derivatives, e.g. of N-(2-methylsulphonylaminoethyl)-N-ethyl-3-methyl-p-phenylenediamine (CD-3) and of N-(2-hydroxyethyl)-N-ethyl-3-methyl-p-phenylenediamine (CD-4).

p-phenylenediamine derivatives, particularly the aforementioned compounds CD-3 and CD-4, are known developer substances for colour photographic silver halide materials. They are normally used as a concentrated solution in sulphuric acid. This acidic solution is very stable due to a small addition of sulphite. The free bases of p-phenylenediamine derivatives are very susceptible to oxidation, however, both in solution and in solid form.

If a sulphuric acid concentrate of p-phenylenediamine derivatives is neutralised with alkali hydroxides, precipitates are formed in the concentrate.

For use in one-part colour developer concentrates, however, neutralisation is absolutely necessary, since colour development only occurs under alkaline conditions. Therefore, the colour developer concentrate already has to be alkaline. In order to produce different colour developer formulations, there is therefore a need for a stable, alkaline p-phenylenediamine derivative which can be used universally.

The present invention thus relates to a concentrated, aqueous solution of a p-phenylenediamine derivative, characterised in that it

a) has a pH higher than 12.5,

b) contains 0.4 to 1.1 mol p-phenylenediamine derivative/litre,

c) contains 0.05 to 2 mol of an antioxidant/litre,

d) contains at most 35 % by weight of organic solvents with respect to the total solution,

e) contains at most 50 mmol sulphate ions/litre and

f) is single-phase.

The pH is preferably higher than 13.

This concentrated solution can be produced from the free base or from salts of the respective p-phenylenediamine derivative.

Examples of salts of the p-phenylenediamine derivative which can be used include phosphates, chlorides and sulphates. When sulphates are used, the sulphate is separated off, e.g. as an alkali sulphate (as described in EP 0 980 024, paragraph 58).

EP 0 980 024 describes a concentrated alkaline CD-3 solution which contains an antioxidant and which is low in sulphate. This concentrated solution consists of two phases. Phase separation is only suppressed if large amounts of ethylene glycol are added. A two-phase concentrate is unsuitable for the produktion of a colour developer concentrate.

Suitable water-soluble organic solvents include those from the series comprising glycols, polyglycols, alkanolamines, aliphatic and heterocyclic carbonamides, and aliphatic and cyclic monoalcohols.

Examples of suitable water-soluble solvents include derivatives of carboxylic acid amides and derivatives of urea such as dimethylformamide, methylacetamide, dimethylacetamide, N,N′-dimethylurea, tetramethylurea, methanesulphonic acid amide, dimethylethylene-urea, N-acetylglycine, N-valeramide, isovaleramide, N-butyramide, N,N-dimethylbutyramide, N-(2-hydroxyphenyl)-acetamide, N-(2-meth-oxyphenyl)-acetamide, 2-pyrrolidinone, ε-caprolactam, acetanilide, benzamide toluenesulphonic acid amide, phthalimide;

aliphatic and cyclic alcohols e.g. isopropanol, tert.-butyl alcohol, cyclohexanol, cyclohexane-methanol, 1 ,4-cyclohexanedimethanol;

aliphatic and cyclic polyalcohols, e.g. glycols, polyglycols, polymer waxes, tri-methyl-1,6-hexanediol, glycerol, 1,1,1-trimethylolpropane, pentaerythritol, sorbitol;

aliphatic and cyclic ketones, e.g. acetone, ethyl methyl ketone, ethyl ketone, tert.-butyl methyl ketone, diisobutyl ketone, acetylacetone, acetonylacetone, cyclo-pentanone, acetophenone;

esters of aliphatic and cyclic carboxylic acids, e.g. triethoxymethane, methyl acetate, allyl acetate, methyl glycol acetate, ethylene glycol diacetate, glycerol-l-acetate, glycerol diacetate, methylcyclohexyl acetate, methyl salicylate, phenyl salicylate;

aliphatic and cyclic esters of phosphonic acid, e.g. methylphosphonic acid dimethyl ester, allylphosphonic acid diethyl ester;

aliphatic and cyclic oxyalcohols, e.g. 4-hydroxy-4-methyl-2-pentanone, salicyl-aldehyde;

aliphatic and cyclic aldehydes, e.g. acetaldehyde, propanal, trimethylacetaldehyde, crotonaldehyde, glutaraldehyde, 1,2.5,6-tetrahydrobenzaldehyde, benzaldehyde, benzene-propane, terephthalaldehyde;

aliphatic and cyclic oximes, e.g. butanone oxime, cyclohexanone oxime;

aliphatic and cyclic amines (primary, secondary or tertiary), e.g. ethylamine, diethyl-amine, triethylamine, dipropylamine, pyrrolidine, morpholine, 2-amino-pyrimidine;

aliphatic and cyclic polyamines (primary, secondary or tertiary), e.g. ethylene-diamine, 1-amino-2-diethylaminoethane, methyl-bis-(2-methylamino-ethyl)amine, permethyldiethylenetriamine, 1,4-cyclohexanediamine, 1,4-benzene-diamine;

aliphatic and cyclic hydroxyamines, e.g. ethanolamine, 2-methylethylamine, 2-methylaminoethanol, 2-(dimethylamino)ethanol, 2-(2-dim ethylamino-ethoxy)-ethanol, diethanolamine, N-methyldiethanolamine, triethanolamine, 2-(2-aminoethyl- amino)-ethanol, triisopropanolamine, 2-amino-2-hydroxymethyl-1,3-propanediol, 1-piperidine-ethanol, 2-aminophenol, barbituric acid, 2-(4-aminophenoxy)-ethanol, 5-amino-l-naphthol.

Suitable antioxidants are compounds of formulae (I), (II) and (III).

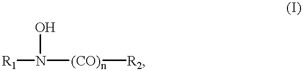

wherein

R₁ denotes an alkyl which is optionally substituted,

R₂ denotes an alkyl which is optionally substituted or an aryl which is optionally substituted, and

n denotes 0 or 1,

preferably those in which at least one of the R₁ and R₂ radicals contains at least one -OH, -COOH or -SO₃H group;

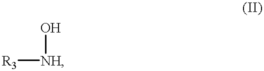

wherein

R₃ denotes an alkyl or acyl group;

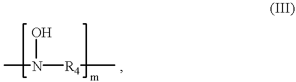

wherein

R₄ denotes an alkylene group which is optionally interrupted by 0 atoms, and

m denotes a number of at least 2.

In addition to the aforementioned types of substitution, the alkyl groups R₁, R₂, R₃, the alkylene group R₄ and the aryl group R₂ can also contain other substituents.

Examples of suitable antioxidants include

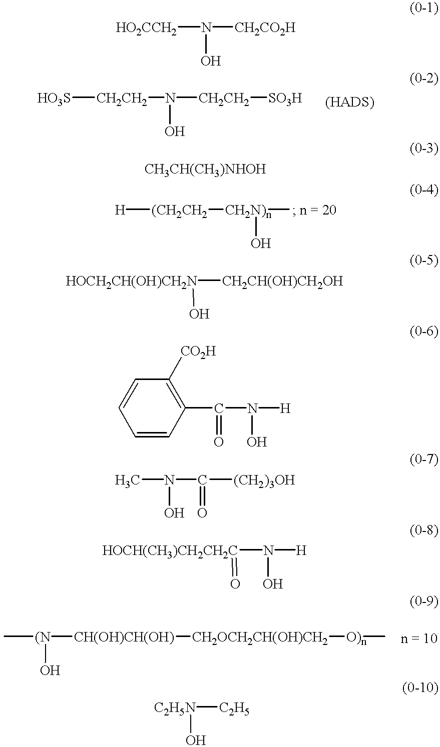

The preferred solvents are alcohols, glycols, polyglycols and caprolactam, and optionally mixtures thereof also. Preferred p-phenylenediamine derivatives are listed in EP 0 980 024, paragraph 28.

### EXAMPLES

### Example 1 (comparison)

| | |
|---|---|
| deionised water | 500 ml |
| aqueous potassium hydroxide solution, | 100 ml |
| 45% by weight | |
| diethylhydroxylamine, 85% by weight | 200 ml |
| CD 3 base | 190 g |
| made up to 1000 ml with deionised water | |
| pH 11.5 | |

CD 3 was precipitated from this single-phase solution after
a short period of time.

### Example 2 (comparison)

| | |
|---|---|
| deionised water | 700 ml |
| aqueous potassium hydroxide solution | 150 ml |
| 45% by weight | |
| HADS | 150 g |
| CD 3 base | 190 g |
| made up to 1000 ml with deionised water | |
| pH 11.5 | |

CD 3 was precipitated from this single-phase solution after
a short period of time.

### Example 3 (invention)

| | |
|---|---|
| deionised water | 300 ml |
| aqueous potassium hydroxide solution, | 300 ml |
| 45% by weight | |
| diethylhydroxylamine, 85% by weight | 200 ml |
| CD 3 base | 190 g |
| made up to 1000 ml with deionised water | |
| pH 14 | |

No precipitate was formed from this single-phase solution,
even after a long period of time.

### Example 4 (invention)

| | |
|---|---|
| deionised water | 400 ml |
| aqueous potassium hydroxide solution, | 350 ml |
| 45% by weight | |
| HADS | 150 g |
| CD 3 base | 190 g |
| made up to 1000 ml with deionised water | |
| pH 14 | |

No precipitate was formed from this single-phase solution,
even after a long period of time.

### Example 5 (invention)

| | |
|---|---|
| deionised water | 200 ml |
| aqueous potassium hydroxide solution, | 360 ml |
| 45% by weight | |
| diethylhydroxylamine, 85% by weight | 200 ml |
| CD 3 phosphate | 220 g |
| made up to 1000 ml with deionised water | |
| pH 14 | |

No precipitate was formed from this single-phase solution,
even after a long period of time.

### Example 6 (invention)

| | |
|---|---|
| deionised water | 200 ml |
| aqueous potassium hydroxide solution, | 400 ml |
| 45% by weight | |
| diethylhydroxylamine, 85% by weight | 200 ml |
| CD 3 sulphate | 300 g |
| diethylene glycol | 100 ml |
| made up to 1000 ml with deionised water | |
| pH 14 | |

Potassium sulphate, the solubility of which was low, was even precipitated during the dissolution of CD 3. In order to complete this precipitation, the batch was allowed to stand for one day whilst being cooled to minus 10C. The precipitated potassium sulphate was separated from the supernatant solution. The filtrate was a single-phase solution which was low in sulphate and from which nothing was precipitated even after a long period of time.

At a sufficiently high pH (Examples 3 to 6), the single-phase, low-sulphate concentrates remained stable.

1. A concentrated aqueous solution of a p-phenylenediamine derivative, characterised in that it
a) has a pH higher than 12.5,
b) contains 0.4 to 1.1 mol p-phenylenediamine derivative/litre,
c) contains 0.05 to 2 mol of an antioxidant/litre,
d) contains at most 35 % by weight of organic solvents with respect to the total solution,
e) contains at most 50 mmol sulphate ions/litre and
f) is single-phase.

2. A concentrated, aqueous solution according to claim 1, characterised in that the antioxidant corresponds to one of formulae (I), (II) and (III) 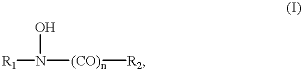
wherein
R₁ denotes an alkyl which is optionally substituted,
R₂ denotes an alkyl which is optionally substituted or an aryl which is optionally substituted, and
n denotes 0 or 1; 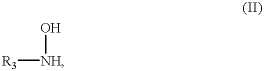
wherein
R₃ denotes an alkyl or acyl group; 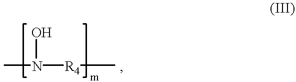
wherein
R₄ denotes an alkylene group which is optionally interrupted by 0 atoms, and
m denotes a number of at least 2.

3. A concentrated, aqueous solution according to claim 1, characterised in that the p-phenylenediamine derivative is CD-3 or CD-4.

4. A concentrated, aqueous solution according to any of claims 1 to 3, characterised in that the antioxidant is diethylhydroxylamine or di-(2-sulphoethyl)-hydroxylamine.

5. A concentrated, aqueous solution according to any of claims 1 to 4, characterised in that it contains up to 0.5 mol sulphite/litre or up to 0.5 mol hydroxylamine/litre as an additional antioxidant.

6. A concentrated, aqueous solution according to any of claims 1 to 5, characterised in that it contains up to 35 % by weight, with respect to the total solution, of water-soluble organic solvents.

7. Use of the concentrated solution according to claim 1 for the production of one-part colour developer concentrates.
